(19) United States
(12) Patent Application Publication
(10) Pub. No.: US 2024/0346234 A1
(43) Pub. Date: Oct. 17, 2024

(54) STRUCTURED DOCUMENT GENERATION FROM TEXT PROMPTS

(71) Applicant: ADOBE INC., SAN JOSE, CA (US)

(72) Inventors: Xinyang Zhang, Santa Clara, CA (US); Wentian Zhao, San Jose, CA (US); Xin Lu, Saratoga, CA (US); Jen-Chan Chien, Saratoga, CA (US)

(21) Appl. No.: 18/300,721

(22) Filed: Apr. 14, 2023

(51) Int. Cl. G06F 40/166; G06F 40/103; G06V 30/41

(52) U.S. Cl. CPC G06F 40/166; G06F 40/103; G06V 30/41

(57) ABSTRACT

Systems and methods for document processing are provided. One aspect of the systems and methods includes obtaining a prompt including a document description describing a plurality of elements. A plurality of image assets are generated based on the prompt using a generative neural network. In some cases, the plurality of image assets correspond to the plurality of elements of the document description. A structured document is then generated that matches the document description. In some cases the structured document includes the plurality of image assets and metadata describing a relationship between the plurality of image assets.

### BACKGROUND

The following relates generally to machine learning, and more specifically to machine learning for document processing.

Digital document editing (or document processing) refers to the process of making changes to a digital document using a computer or other electronic device. This may include adding, deleting, or modifying text, images, and other content in a document. Various applications or tools may support different functionalities for creating and editing documents, and these tools may be used to create and edit a wide range of documents. Furthermore, digital documents may be used for a wide variety of communication tasks including the reproduction of formal documents, communicating through online advertisements, social media posts, flyers, posters, billboards, web and mobile application prototypes, etc.

### SUMMARY

The present disclosure describes systems and methods for document processing. Embodiments of the present disclosure include a document processing apparatus configured to generate a structured document (e.g., a Photoshop Document (PSD), a portable document format (PDF) document, etc.) based on a prompt from a user. The document processing apparatus may generate a text embedding based on the prompt, generate a latent vector based on the text embedding, and decode the latent vector to obtain multiple document assets (e.g., image assets) for the structured document. The document processing apparatus may then create a structured document by combining the document assets (e.g., into different layers such as a background layer and a foreground layer). Thus, the document processing apparatus may be used to create coherent structured documents (e.g., rather than simple images).

A method, apparatus, non-transitory computer readable medium, and system for machine learning for document processing are described. One or more aspects of the method, apparatus, non-transitory computer readable medium, and system include obtaining a prompt including a document description describing a plurality of elements; generating a plurality of image assets based on the prompt using a generative neural network, wherein the plurality of image assets correspond to the plurality of elements of the document description; and generating a structured document matching the document description, wherein the structured document includes the plurality of image assets and metadata describing a relationship between the plurality of image assets.

A method, apparatus, non-transitory computer readable medium, and system for machine learning for document processing are described. One or more aspects of the method, apparatus, non-transitory computer readable medium, and system include obtaining training data including a structured document and a document description of the structured document, wherein the structured document includes a plurality of image assets and metadata describing a relationship between the plurality of image assets and training a generative neural network using the training data, wherein the generative neural network is trained to generate the plurality of image assets based on the document description.

An apparatus, system, and method for machine learning for document processing are described. One or more aspects of the apparatus, system, and method include at least one memory component; at least one processing device coupled to the at least one memory component, where the processing device is configured to execute instructions stored in the at least one memory component; a generative neural network including parameters stored in the at least one memory component, wherein the generative neural network is configured to generate a plurality of image assets based on a prompt; and a document generator configured to generate a structured document including the plurality of image assets and metadata describing a relationship between the plurality of image assets.

### BRIEF DESCRIPTION OF THE DRAWINGS

FIG. 1 shows an example of a document processing system according to aspects of the present disclosure.

FIG. 2 shows an example of a document processing apparatus according to aspects of the present disclosure.

FIG. 3 shows an example of a guided latent diffusion model according to aspects of the present disclosure.

FIG. 4 shows an example of a method for document processing according to aspects of the present disclosure.

FIG. 5 shows an example of a process for document processing according to aspects of the present disclosure.

FIG. 6 shows a diffusion process according to aspects of the present disclosure.

FIGS. 7 and 8 show examples of methods for machine learning according to aspects of the present disclosure.

FIG. 9 shows an example of a method for training a diffusion model according to aspects of the present disclosure.

FIG. 10 shows an example of a computing device for document processing according to aspects of the present disclosure.

### DETAILED DESCRIPTION

The present disclosure describes systems and methods for document processing. Embodiments of the present disclosure include a document processing apparatus configured to generate a structured document (e.g., a Photoshop Document (PSD), a portable document format (PDF) document, etc.) based on a prompt from a user. The document processing apparatus may generate a text embedding based on the prompt, generate a latent vector based on the text embedding, and decode the latent vector to obtain multiple document assets for the structured document. The document processing apparatus may then create a structured document by combining the document assets (e.g., into different layers such as a background layer and a foreground layer). Thus, the document processing apparatus may be used to create coherent structured documents (e.g., rather than simple images).

Several text-to-image generation models have been introduced that allow for image generation based on text prompts. Some image generation models build upon existing models through post-processing or use the existing models as foundation models for optimization tasks. In some examples, however, images generated using image generation models may be simple. For instance, different aspects of the images or different content in the images may not be represented in an image file format (e.g., at least not in a way that is convenient for editing). As a result, users may preprocess these images to prepare these images for editing, and such preprocessing may be time consuming and inconvenient.

Embodiments of the present disclosure include a document processing apparatus configured to generate a structured document based on a prompt from a user. The structured document may include multiple document assets and metadata describing a relationship between the document assets. The document processing apparatus may include a multimodal encoder, a generative neural network, a decoder, and a document generator. The multimodal encoder may obtain a prompt from a user and generate a text embedding based on the prompt. The generative neural network may generate a latent vector corresponding to multiple document assets of a structured document based on the text embedding. The decoder may decode the latent vector to obtain the document assets. And the document generator may create a structured document by combining the document assets.

In some embodiments, the document processing apparatus may be trained using training data including structured documents and user prompts. Each of the structured documents may include multiple document assets and metadata describing a relationship between the document assets. The multimodal encoder of the document processing apparatus may be pretrained to encode text prompts into text embeddings. The generative neural network of the document processing apparatus may be trained to generate latent vectors representing document assets based on text embeddings and noise vectors corresponding to the document assets. Additionally, the decoder of the document processing apparatus may be trained to decode latent vectors to obtain document assets (e.g., based on being trained on the reverse task of encoding document assets as latent vectors).

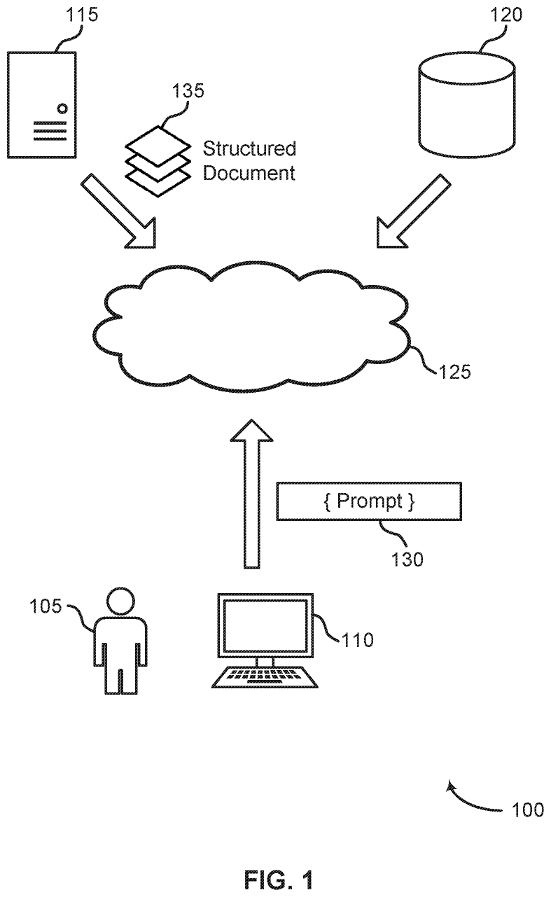

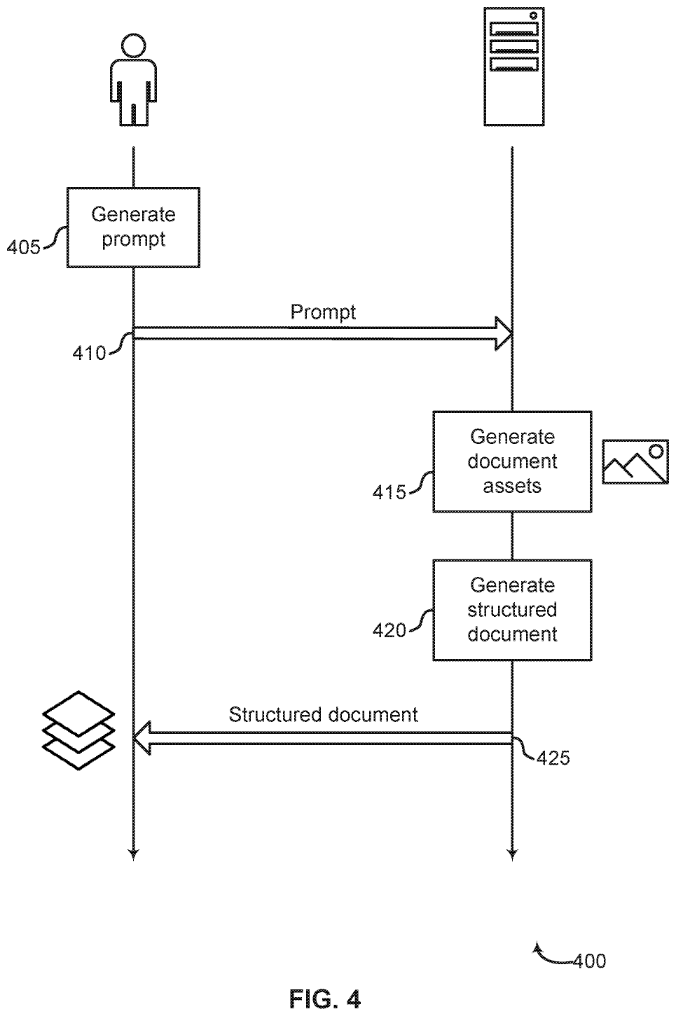

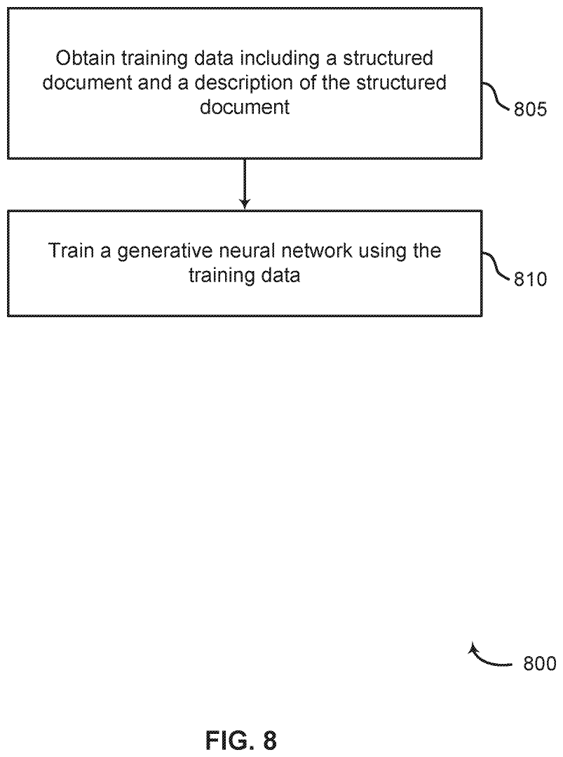

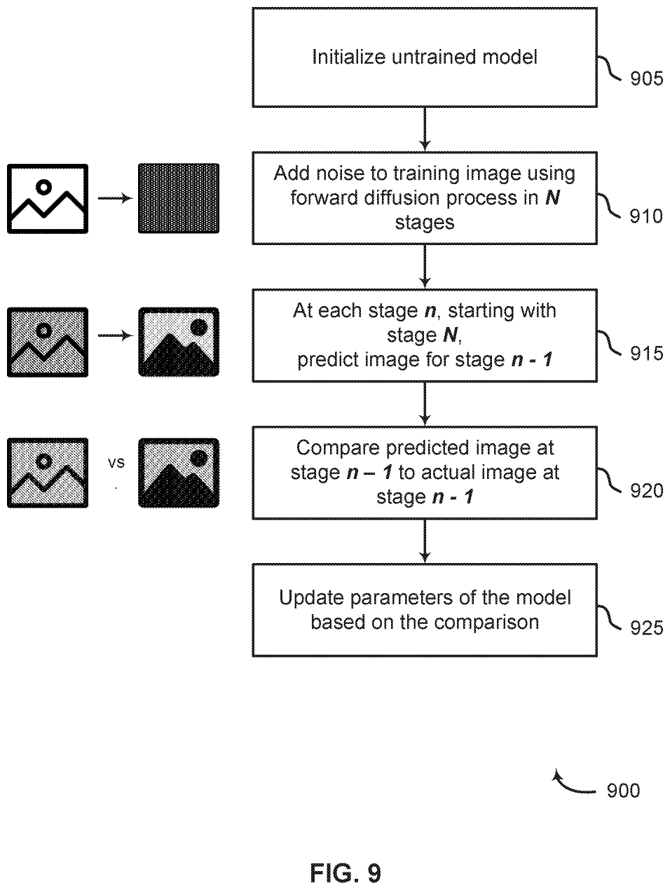

Some embodiments of the present disclosure improve on conventional document editing platforms by enabling the generation and editing of structured documents (e.g., documents with multiple layers) rather than being limited to simple images. Examples of a document processing apparatus described herein may be used to generate coherent structured documents from user prompts. Users may edit these documents more quickly and easily without performing any additional preprocessing (e.g., or with less additional preprocessing). For example, if the document processing apparatus is trained to generate documents in a PSD file format rather than images in another file format, users may be able to import the generated documents to an image editor and begin editing. Details regarding the architecture of an example document processing apparatus are provided with reference to FIGS. 1-3. Example processes for document processing are provided with reference to FIGS. 4-7. Example training processes are described with reference to FIGS. 8 and 9.

### Network Architecture

In FIGS. 1-3, a system for machine learning for document processing is described. The system includes at least one memory component; at least one processing device coupled to the at least one memory component, where the processing device is configured to execute instructions stored in the at least one memory component; a generative neural network including parameters stored in the at least one memory component, where the generative neural network is configured to generate a set of image assets based on a prompt; and a document generator configured to generate a structured document including the set of image assets and metadata describing a relationship between the set of image assets.

In some aspects, the system includes a decoder configured to decode a latent vector generated by the generative neural network to obtain the set of image assets. In some aspects, the decoder includes a decoder of a VAE model. In some aspects, the system includes a text encoder configured to encode the prompt to obtain a text embedding, where the set of image assets are generated based on the text embedding. In some aspects, the text encoder includes a multimodal text encoder configured to encode text and images in a joint embedding space. In some aspects, the generative neural network includes a diffusion model based on a UNet architecture.

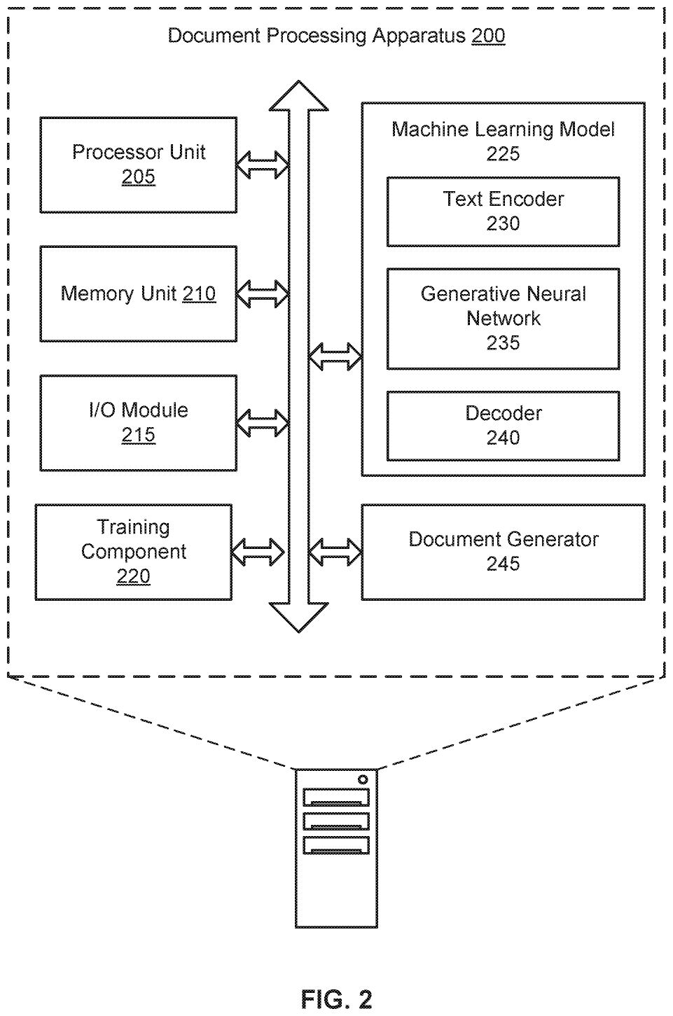

FIG. 1 shows an example of a document processing system 100 according to aspects of the present disclosure. In one aspect, document processing system 100 includes user 105, user device 110, document processing apparatus 115, database 120, and cloud 125. Document processing apparatus 115 is an example of, or includes aspects of, the corresponding element described with reference to FIG. 2.

A user 105 may interact with document processing software on user device 110. The user device 110 may communicate with the document processing apparatus 115 via the cloud 125. In some examples, the user 105 may provide a prompt 130 to the document processing apparatus 115 via the user device 110, and the document processing apparatus 115 may generate a structured document 135 based on the prompt 130. The structured document 135 may include multiple document assets and metadata describing a relationship between the document assets. The document processing apparatus 115 may then provide the structured document 135 to the user 105 via the user device 110.

In some examples, the document processing apparatus 115 may include a server. A server provides one or more functions to users (e.g., a user 105) linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device (e.g., user device 110), a personal computer, a laptop computer, a mainframe computer, a super computer, or any other suitable processing apparatus.

A database 120 is an organized collection of data. For example, a database 120 stores data in a specified format known as a schema. A database 120 may be structured as a single database, a distributed database, multiple distributed databases, or an emergency backup database. In some cases, a database controller may manage data storage and processing in a database. In some cases, a user 105 interacts with a database controller. In other cases, a database controller may operate automatically without user interaction.

A cloud 125 is a computer network configured to provide on-demand availability of computer system resources, such as data storage and computing power. In some examples, the cloud 125 provides resources without active management by the user 105. The term “cloud” is sometimes used to describe data centers available to many users over the Internet. Some large cloud networks have functions distributed over multiple locations from central servers. A server is designated an edge server if the server has a direct or close connection to a user. In some cases, a cloud 125 is limited to a single organization. In other examples, the cloud 125 is available to many organizations. In one example, a cloud 125 includes a multi-layer communications network comprising multiple edge routers and core routers. In another example, a cloud 125 is based on a local collection of switches in a single physical location.

A user device 110 (e.g., a computing device) is a personal computer, laptop computer, mainframe computer, palmtop computer, personal assistant, mobile device, or any other suitable processing apparatus. In one aspect, document processing system 100 includes user 105, user device 110, document processing apparatus 115, database 120, and cloud 125. Document processing apparatus 115 is an example of, or includes aspects of, the corresponding element described with reference to FIG. 2.

FIG. 2 shows an example of a document processing apparatus 200 according to aspects of the present disclosure. In one aspect, document processing apparatus 200 includes processor unit 205, memory unit 210, I/O module 215, training component 220, machine learning model 225, and document generator 245. The machine learning model 225 includes text encoder 230, generative neural network 235, and decoder 240, Document processing apparatus 200 is an example of, or includes aspects of, the corresponding element described with reference to FIG. 1.

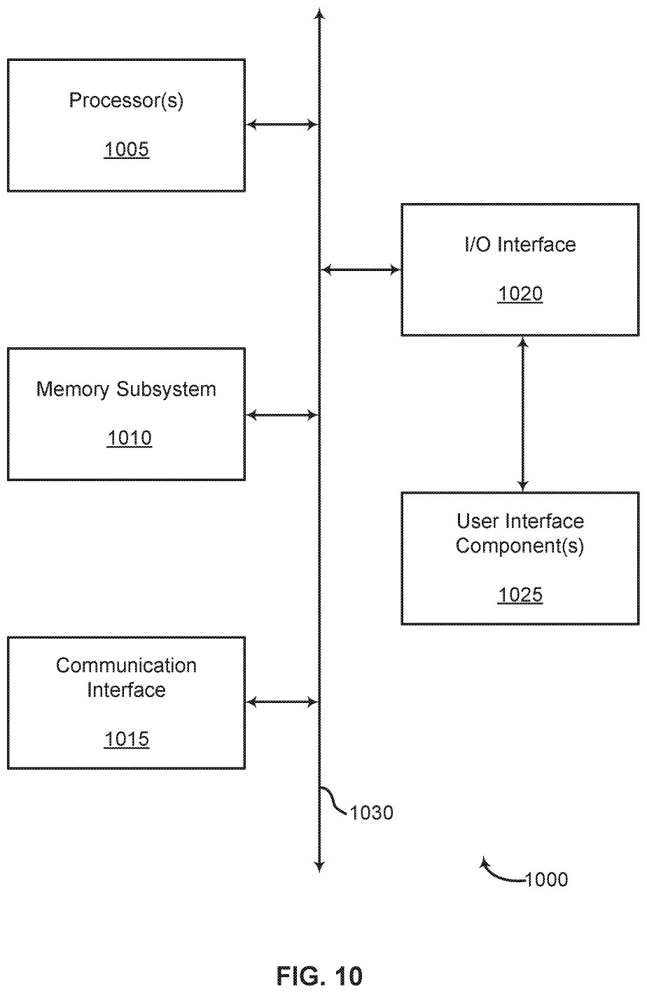

Processor unit 205 comprises a processor. Processor unit 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 205 is configured to operate a memory array using a memory controller. In other cases, a memory controller is integrated into the processor unit 205. In some cases, the processor unit 205 is configured to execute computer-readable instructions stored in a memory to perform various functions. In some embodiments, a processor unit 205 includes special-purpose components for modem processing, baseband processing, digital signal processing, or transmission processing. The processor unit 205 is an example of, or includes aspects of, the processor described with reference to FIG. 10.

Memory unit 210 comprises a memory including instructions executable by the processor. Examples of a memory unit 210 include random access memory (RAM), read-only memory (ROM), or a hard disk. Examples of memory units 210 include solid state memory and a hard disk drive. In some examples, memory is used to store computer-readable, computer-executable software including instructions that, when executed, cause a processor to perform various functions described herein. In some cases, the memory unit 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 210 store information in the form of a logical state. The memory unit 210 is an example of, or includes aspects of, the memory subsystem described with reference to FIG. 10.

I/O module 215 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via I/O controller or via hardware components controlled by an I/O controller. The I/O module 215 is an example of, or includes aspects of, the I/O interface described with reference to FIG. 10.

In some examples, I/O module 215 includes a user interface. A user interface may enable a user to interact with a device. In some embodiments, the user interface may include an audio device, such as an external speaker system, an external display device such as a display screen, or an input device (e.g., remote-control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna. A user interface of I/O module 215 may be an example of, or includes aspects of, the user interface component described with reference to FIG. 10.

In some examples, document processing apparatus 200 includes a computer-implemented artificial neural network (ANN) to generate classification data for a set of samples. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

In some examples, document processing apparatus 200 includes a computer-implemented convolutional neural network (CNN). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In some examples, document processing apparatus 200 includes a transformer. A transformer or transformer network is a type of neural network model used for natural language processing tasks. A transformer network transforms one sequence into another sequence using an encoder and a decoder. The encoder and decoder include modules that can be stacked on top of each other multiple times. The modules comprise multi-head attention and feedforward layers. The inputs and outputs (target sentences) are first embedded into an n-dimensional space. Positional encoding of the different words (i.e., give every word/part in a sequence a relative position since the sequence depends on the order of its elements) is added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q corresponds to a matrix that contains the query (vector representation of one word in the sequence), K corresponds to all the keys (vector representations of all the words in the sequence), and V corresponds to the values, which are again the vector representations of all the words in the sequence. For the encoder and decoder, multi-head attention modules, V consists of the same word sequence as Q. However, for the attention module that is taking into account the encoder and the decoder sequences, V is different from the sequence represented by Q. In some cases, values in V are multiplied and summed with some attention-weights a.

In some examples, the decoder 240 is a decoder of a variational auto encoder (VAE) model. A VAE is a generative model that uses deep learning to compress and decompress data, typically for the purpose of generating new samples. The VAE combines a traditional autoencoder architecture with the mathematical concept of variational inference. The encoder part of the VAE takes in an input data sample and compresses it into a lower-dimensional latent representation (e.g., a latent vector). The decoder part of the VAE then takes the latent representation and generates a reconstruction of the original data sample. During training, the VAE minimizes the difference between the generated reconstruction and the input sample, while also maximizing the likelihood of the latent representation according to a specified prior distribution. Thus, a VAE may be used to generate new samples that are similar to original data, and the VAE may improve the performance of generative models and reduce the dimensionality of data to make it easier to visualize and understand.

In some examples, the text encoder 230 is a multilingual, multimodal encoder, such as a contrastive language-image pre-training (CLIP) encoder. CLIP is a neural network-based model that is trained on a massive dataset of images and text (e.g., image captions). CLIP uses a technique called contrastive learning to learn underlying patterns and features of data. This allows CLIP to understand the relationships between different objects and scenes in images, and to classify the objects and scenes based on the content in the objects and scenes. CLIP is multimodal in that it can process and understand multiple types of data inputs, such as text and images. In some examples, CLIP can be fine-tuned for specific tasks, such as recognizing specific objects in images. CLIP's ability to generalize from one task to another and to be fine-tuned for new tasks makes it a highly versatile model.

In some examples, the training component 220 is implemented as software stored in memory and executable by a processor of a separate computing device, as firmware in the separate computing device, as one or more hardware circuits of the separate computing device, or as a combination thereof. In some examples, training component 220 is part of another apparatus other than document processing apparatus 200 and communicates with the document processing apparatus 200.

According to some aspects, text encoder 230 obtains a prompt including a document description describing a set of elements. According to some aspects, generative neural network 235 generates a set of image assets based on the prompt, where the set of image assets correspond to the set of elements of the document description. According to some aspects, document generator 245 generates a structured document matching the document description, where the structured document includes the set of image assets and metadata describing a relationship between the set of image assets.

In some examples, text encoder 230 encodes the prompt to obtain a text embedding, where the set of image assets are generated based on the text embedding.

In some examples, generative neural network 235 initializes a noise vector in a latent space representing a set of document parts. In some examples, generative neural network 235 generates a latent vector representing the set of image assets based on the noise vector. According to some aspects, decoder 240 decodes the latent vector to obtain the set of document assets, where the set of image assets correspond to the set of document parts respectively.

In some examples, decoder 240 decodes the latent vector to obtain a parameter for displaying an asset of the set of image assets.

In some aspects, the latent vector is generated using a denoising diffusion implicit model (DDIM) process.

In some examples, generative neural network 235 generates an additional asset based on the set of image assets provided as input, where the structured document includes the additional asset.

In some examples, text encoder 230 obtains an additional prompt, where the additional asset is generated based on the additional prompt.

In some aspects, the set of image assets includes a background image and a foreground image, and the relationship includes a layer ordering of the background image and the foreground image.

According to some aspects, training component 220 obtains training data including a structured document and a document description of the structured document, where the structured document includes a set of image assets and metadata describing a relationship between the set of image assets. In some examples, training component 220 trains a generative neural network 235 using the training data, where the generative neural network 235 is trained to generate the set of image assets based on the document description.

In some examples, training component 220 generates a set of noise vectors corresponding to the structured document. According to some aspects, generative neural network 235 generates a set of predicted vectors corresponding to the set of noise vectors, respectively. In some examples, training component 220 compares the set of predicted vectors to the set of noise vectors, where the training is based on the comparison.

According to some aspects, machine learning model 225 encodes the set of image assets to obtain a latent vector in a latent space representing a set of document parts, where the generative neural network 235 is trained to generate the latent vector.

In some examples, training component 220 trains an encoder to encode the set of image assets.

In some aspects, the generative neural network 235 is trained using a denoising diffusion probabilistic model (DDPM) process.

According to some aspects, text encoder 230 encodes the document description to obtain an encoded description, where the generative neural network 235 is trained to generate the set of image assets based on the encoded description.

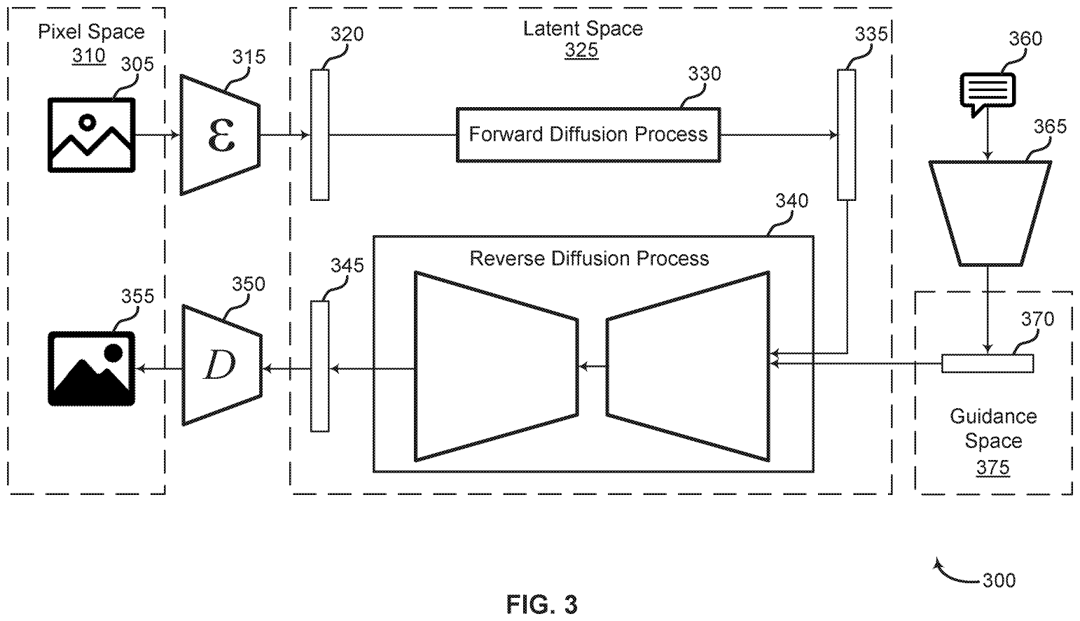

FIG. 3 shows an example of a guided latent diffusion model 300 according to aspects of the present disclosure. The guided latent diffusion model 300 is an example of, or includes aspects of, the generative neural network 235 described with reference to FIG. 2. The guided latent diffusion model 300 may generate a latent vector representing document assets of a structured document based on a prompt from a user.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text or other guidance), image inpainting, and image manipulation.

Types of diffusion models include DDPMs and DDIMs. In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply an image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, image encoder 315 and image decoder 350 are trained jointly, or the image encoder 315 and image decoder 350 are fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340.

### Document Processing

In FIGS. 4-7, a method, apparatus, non-transitory computer-readable medium, and system for machine learning for document processing are described. One or more aspects of the method, apparatus, non-transitory computer-readable medium, and system include obtaining a prompt including a document description describing a plurality of elements; generating a plurality of image assets based on the prompt using a generative neural network, wherein the plurality of image assets correspond to the plurality of elements of the document description; and generating a structured document matching the document description, wherein the structured document includes the plurality of image assets and metadata describing a relationship between the plurality of image assets.

Some examples of the method, apparatus, non-transitory computer readable medium, and system further include encoding the prompt to obtain a text embedding, wherein the plurality of image assets are generated based on the text embedding.

Some examples of the method, apparatus, non-transitory computer readable medium, and system further include initializing a noise vector in a latent space representing a plurality of document parts. Some examples further include generating a latent vector representing the plurality of image assets based on the noise vector using the generative neural network. Some examples further include decoding the latent vector to obtain the plurality of image assets, wherein the plurality of image assets correspond to the plurality of document parts respectively.

Some examples of the method, apparatus, non-transitory computer readable medium, and system further include decoding the latent vector to obtain a parameter for displaying an asset of the plurality of image assets.

In some aspects, the latent vector is generated using a DDIM process.

Some examples of the method, apparatus, non-transitory computer readable medium, and system further include generating an additional asset by providing one or more of the plurality of image assets as input to the generative neural network, wherein the structured document includes the additional asset.

Some examples of the method, apparatus, non-transitory computer readable medium, and system further include obtaining an additional prompt, wherein the additional asset is generated based on the additional prompt.

In some aspects, the plurality of image assets includes a background image and a foreground image, and wherein the relationship comprises a layer ordering of the background image and the foreground image.

FIG. 4 shows an example of a method 400 for document processing according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, a user may generate a prompt for generating a document. The prompt may specify attributes of the document to be generated, and a document processing apparatus may use the prompt to generate the document. In some cases, the operations of this step refer to, or may be performed by, a user as described with reference to FIG. 1.

At operation 410, the user may provide the prompt to the document processing apparatus. In some examples, the user may provide the prompt to the document processing apparatus via a user device. In some cases, the operations of this step refer to, or may be performed by, a user as described with reference to FIG. 1.

At operation 415, the document processing apparatus may generate multiple document assets based on the prompt. For example, the document processing apparatus may initialize a noise vector, generate a latent vector representing the document assets based on the noise vector, and decode the latent vector to obtain the document assets. In some cases, the operations of this step refer to, or may be performed by, a generative neural network and a decoder as described with reference to FIG. 2.

At operation 420, the document processing apparatus may generate a structured document. The structured document may include the document assets generated at operation 415 and may also include metadata describing a relationship between the document assets. In some cases, the operations of this step refer to, or may be performed by, a document generator as described with reference to FIG. 2.

At operation 425, the document processing apparatus may provide the structured document to the user. In some examples, the document processing apparatus may provide the structured document to the user via a user interface. In some cases, the operations of this step refer to, or may be performed by, a document processing apparatus as described with reference to FIGS. 1 and 2.

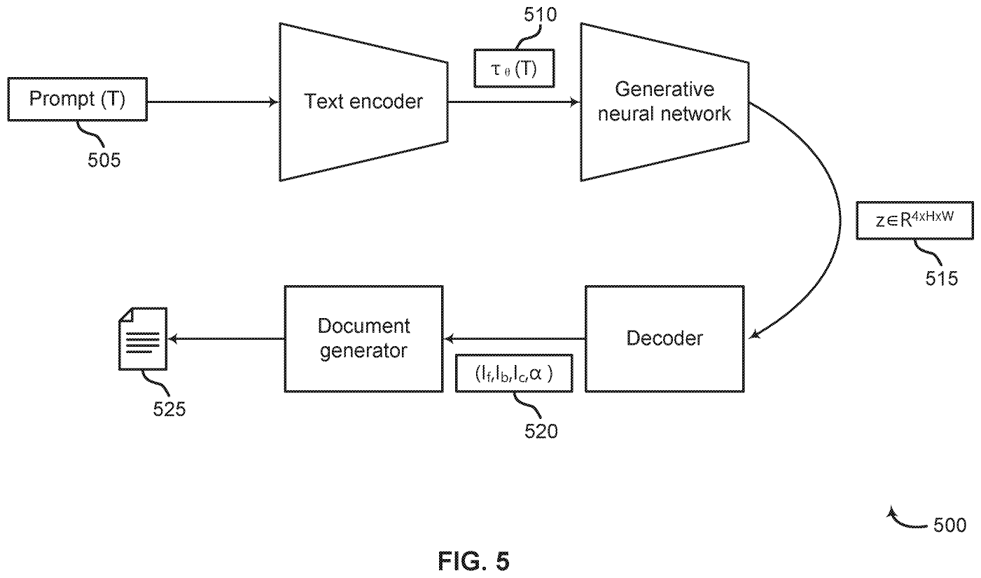

FIG. 5 shows an example of a process 500 for document processing according to aspects of the present disclosure. A document processing apparatus may implement the process 500 to generate structured documents based on user prompts. Examples of file formats of structured documents that may be generated by the document processing apparatus include PSD, PDF, etc. These file formats and others may include multiple layers and objects and may be used by designers and artists (e.g., for document creation, document editing, etc.). In some examples, it may be challenging for users to create files in these file formats (e.g., by masking out objects in a document manually or performing other pre-processing tasks). The process 500 may support the generation of structured documents in these file formats to alleviate the burden on users to create or convert files to these file formats.

A document processing apparatus implementing the process 500 may support systems, methods, or techniques (e.g., diffusion methods) for generating structured documents (e.g., PSD documents) automatically in an end-to-end manner. Such systems, methods, or techniques may largely boost the efficiency of art design and other practices. In some examples, the document processing apparatus may also generate structured documents conditioned on (e.g., using) existing structured documents, which may be useful to users of editing software. Structured documents (e.g., PSD), which may be multi-layer by nature, may be different from simple images in that assets or content of the documents may be more accessible (e.g., to a user through an editing software).

By directly generating structured documents, users that are new to document creation and editing may be able to get started using file formats (e.g., PSD, PDF, etc.) suited to document creation and editing (e.g., non-disruptive editing). Accordingly, these users may be onboarded more easily. A document processing apparatus implementing the process 500 may produce multiple image layers together with an alpha channel, layer mask, blending method, etc. The process 500 may also be expanded for generating various structured documents, including design templates or design files. In some examples, the process 500 may be used in one or more workflows, including compositing, retouching, etc. Some operations of the process 500 may be optimized and a model implementing the process 500 may be converted to other formats for faster execution (e.g., a Core ML format, which may be run on Metal Performance Shaders (MPS) in 10 seconds on an Apple M1 Max chip).

In the example of FIG. 5, a document processing apparatus may be trained to generate a structured document 525 including a foreground image (I_{f}), a background image (I_{b}), a composed image (I_{c}), and an alpha matte of the foreground (α) given a text prompt T (e.g., prompt 505) as input. In other examples, the document processing apparatus may be trained to generate a structured document 525 including more layers, fewer layers, different layers, or even different parameters (e.g., a parameter for displaying an asset, such as an alpha matte, brightness, etc.). The document processing apparatus may also be trained based on one or more types of user prompts (e.g., prompts specifying a layout, image, text, style, color, or body position).

The document processing apparatus may include a text encoder (e.g., a multimodal text encoder), a generative neural network (e.g., a diffusion model), an autoencoder (e.g., including a decoder), and a document generator. Components of the document processing apparatus may be trained independently or in any combination such that the document processing apparatus may be used after training to generate structured documents (e.g., structured document 525) based on user prompts (e.g., prompt 505). Training data used to train the document processing apparatus may include pairs of structured documents and user prompts. The document assets in a structured document 525 may each be represented as an element of a tuple. In some examples, during training, each of the elements of the tuple may be provided as noise, provided with no noise, or provided with some noise. As such, the training data may be used to guide the document processing apparatus to focus on generating specific document assets.

The autoencoder may be trained to project a tuple (I_{f}, I_{b}, I_{c}, α) to a latent space to produce a latent representation (e.g., a feature) z∈R^{4×H×W}. The text encoder may be used to project text prompts T to an intermediate representation τ_{θ}(T) (e.g., a text embedding), which may be fed into the generative neural network (e.g., the intermediate layers of a UNet diffusion module via a cross-attention mechanism). The generative neural network may be trained to take inputs zₜ, t, and τ_{θ}(T) at a current time step and predict the noise added to the current time step ∈_{θ}(zₜ, t, τ_{θ}(T)). In some examples, the generative neural network may be a diffusion model, and the diffusion model may be trained to follow the workflow of DDPM An L2 norm may be applied to penalize a difference between predicated noise ∈_{θ}(zₜ, t, τ_{θ}(T)) and ground truth noise ∈ according to the following:

$$L := {E}_{{z}_{t} , ϵ ∼ N ( 0 , 1 ) , t} [ ‖ ϵ - {ϵ}_{θ} ( {z}_{t} , t , {τ}_{θ} ( T ) ) ‖ ] . \qquad ( 1 )$$

During inference, a user may provide a prompt 505 to the document processing apparatus, and the text encoder of the document processing apparatus may generate a text embedding 510 based on the prompt 505. A generative neural network may generate a latent vector 515 representing multiple document assets based on the text embedding 510, and a decoder may decode the latent vector 515 to obtain the document assets 520. A document generator may then generate a structured document 525 including the document assets 520 and metadata describing a relationship between the document assets 520. In some examples, the document processing apparatus may take document assets as inputs in addition to a text prompt for further guidance in generating a structured document. Each of the document assets may be provided with any amount of noise (e.g., depending on the information available to a user).

A diffusion model of the present disclosure may follow the workflow of DDIM in the inference phase, which may produce samples with comparable quality to DDPM while using fewer time steps. For instance, DDIM may use 20 or 50 time steps and may be 20 or 50 times faster than DDPM. In some examples, starting noise of a reverse diffusion process may be sampled as z_{T}˜N(0,1), and from time step T to time step 1, noise may be sampled as ∈ₜ˜N(0,1). Then, a denoised, latent vector zₜ₋₁ may be iteratively computed as follows:

$${z}_{t - 1} = \sqrt{{α}_{t - 1}} ( {z}_{t} - \frac{\sqrt{1 - {α}_{t}} {ϵ}_{θ}^{( t )} ( {z}_{t} )}{\sqrt{{α}_{t}}} ) + \sqrt{1 - {α}_{t - 1} - {σ}_{t}^{2}} \cdot {ϵ}_{θ}^{( t )} ( {z}_{t} ) + {σ}_{t} {ϵ}_{t} . \qquad ( 2 )$$

In equation 2, σₜ may be the coefficient which controls the diversity of generated documents (e.g., structured document 525). Then, z₀ may be fed into a bottleneck layer of a pretrained VAE, which may recover the tuple (I_{f}, I_{b}, I_{c}, α).

In some examples, the generative neural network used to generate latent representations (e.g., latent vector 515) of document assets (e.g., document assets 520) may include one or more generative models. In one example, the generative neural network may include a single, generative model that may generate a single, latent representation of multiple document assets in a latent space. In another example, the generative neural network may include multiple generative models, such that at least one document asset may be generated by a different generative model from another document asset. In some examples, one generative model in the generative neural network may be able to identify the internal state of another generative model in the generative neural network. In some examples, the latent space for one document asset may be different from the latent space for another document asset. In some examples, although different document assets may be associated with different latent spaces, the generative neural network may still generate a latent representation of multiple document assets in a single latent space.

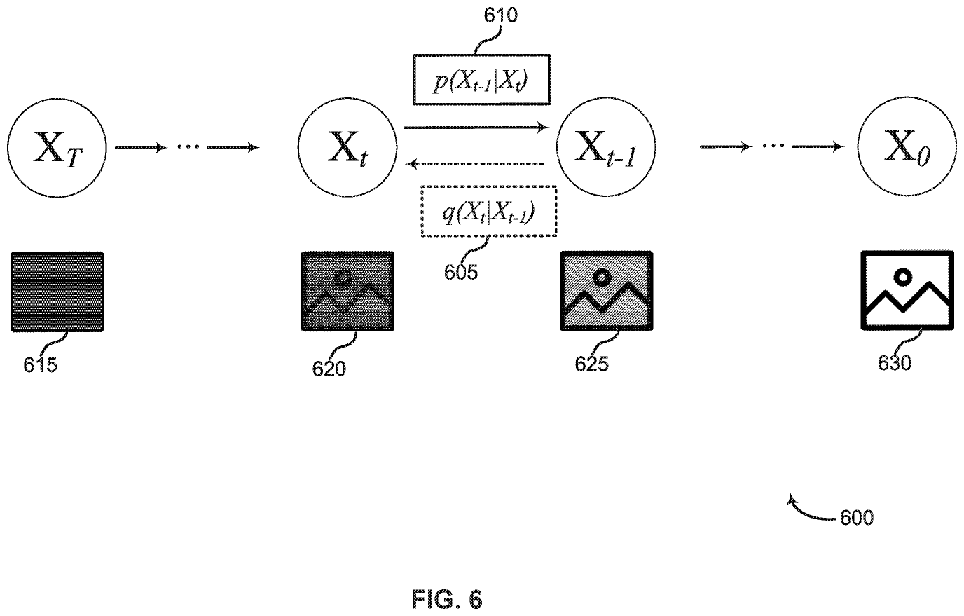

FIG. 6 shows a diffusion process 600 according to aspects of the present disclosure. As described with reference to FIG. 3, a diffusion model can include both a forward diffusion process 605 for adding noise to an image (or features in a latent space) and a reverse diffusion process 610 for denoising the images (or features) to obtain a denoised image. The forward diffusion process 605 can be represented as q(xₜ|xₜ₋₁), and the reverse diffusion process 610 can be represented as p(xₜ₋₁|xₜ). In some cases, the forward diffusion process 605 is used during training to generate images with successively greater noise, and a neural network is trained to perform the reverse diffusion process 610 (i.e., to successively remove the noise).

In an example forward process for a latent diffusion model, the model maps an observed variable x₀ (either in a pixel space or a latent space) and intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 610, the model begins with noisy data x_{T}, such as a noisy image 615, and denoises the data to obtain the p(xₜ₋₁|xₜ). At each step t−1, the reverse diffusion process 610 takes xₜ, such as first intermediate image 620, and t as input. Here, t represents a step in the sequence of transitions associated with different noise levels, The reverse diffusion process 610 outputs xₜ₋₁, such as second intermediate image 625, iteratively until x_{T} is reverted back to x₀, the original image 630. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 4 )$$

where p(x_{T})=N(x_{T}; 0, I) is the pure noise distribution as the reverse process takes the outcome of the forward process, a sample of pure noise, as input and Πₜ₋₁^{T}p_{θ}(xₜ₋₁|xₜ) represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

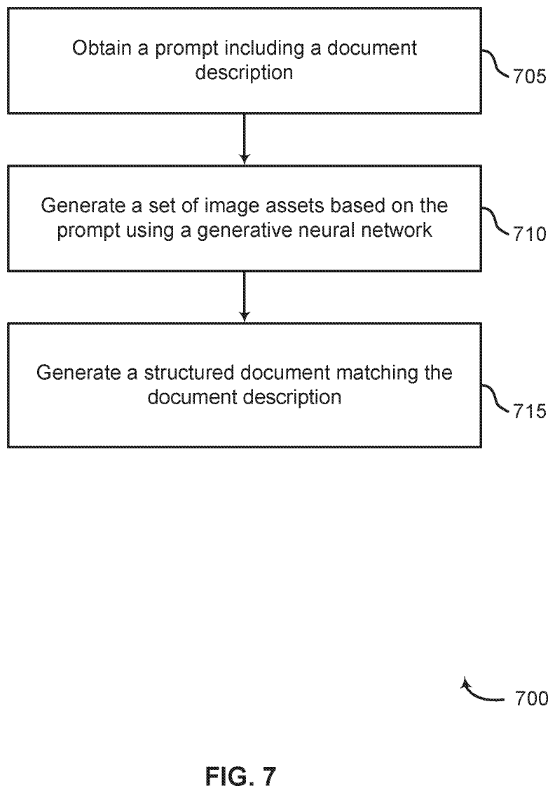

FIG. 7 shows an example of a method 700 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains a prompt including a document description describing a set of elements. In some cases, the operations of this step refer to, or may be performed by, a text encoder as described with reference to FIG. 2.

At operation 710, the system generates a set of image assets based on the prompt using a generative neural network, where the set of image assets correspond to the set of elements of the document description. In some cases, the operations of this step refer to, or may be performed by, a generative neural network as described with reference to FIG. 2.

At operation 715, the system generates a structured document matching the document description, where the structured document includes the set of image assets and metadata describing a relationship between the set of image assets. In some cases, the operations of this step refer to, or may be performed by, a document generator as described with reference to FIG. 2.

### Training

In FIGS. 8 and 9, a method, apparatus, non-transitory computer-readable medium, and system for machine learning for document processing are described. One or more aspects of the method, apparatus, non-transitory computer-readable medium, and system include obtaining training data including a structured document and a document description of the structured document, wherein the structured document includes a plurality of image assets and metadata describing a relationship between the plurality of image assets and training a generative neural network using the training data, wherein the generative neural network is trained to generate the plurality of image assets based on the document description.

Some examples of the method, apparatus, non-transitory computer readable medium, and system further include generating a plurality of noise vectors corresponding to the structured document. Some examples further include generating a plurality of predicted vectors corresponding to the plurality of noise vectors, respectively, using the generative neural network. Some examples further include comparing the plurality of predicted vectors to the plurality of noise vectors, wherein the training is based on the comparison.

Some examples of the method, apparatus, non-transitory computer readable medium, and system further include encoding the plurality of image assets to obtain a latent vector in a latent space representing a plurality of document parts, wherein the generative neural network is trained to generate the latent vector.

Some examples of the method, apparatus, non-transitory computer readable medium, and system further include training an encoder to encode the plurality of image assets.

In some aspects, the generative neural network is trained using a DDPM process.

Some examples of the method, apparatus, non-transitory computer readable medium, and system further include encoding the document description to obtain an encoded description, wherein the generative neural network is trained to generate the plurality of image assets based at least in part on the encoded description.

FIG. 8 shows an example of a method 800 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains training data including a structured document and a document description of the structured document, where the structured document includes a set of image assets and metadata describing a relationship between the set of image assets. In some cases, the operations of this step refer to, or may be performed by, a training component as described with reference to FIG. 2.

At operation 810, the system trains a generative neural network using the training data, where the generative neural network is trained to generate the set of image assets based on the document description. In some cases, the operations of this step refer to, or may be performed by, a training component as described with reference to FIG. 2.

FIG. 9 shows an example of a method 900 for training a diffusion model according to aspects of the present disclosure. The method 900 represents an example for training a reverse diffusion process as described above with reference to FIG. 6. In some examples, these operations are performed by a system including a processor executing a set of codes to control functional elements of an apparatus, such as the document processing apparatus described in FIG. 2.

Additionally, or alternatively, certain processes of method 900 may be performed using special-purpose hardware. Generally, these operations are performed according to the methods and processes described in accordance with aspects of the present disclosure. In some cases, the operations described herein are composed of various substeps, or are performed in conjunction with other operations.

At operation 905, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

At operation 910, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 915, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 920, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 925, the system updates parameters of the model based on the comparison. For example, parameters of a U-Net may be updated using gradient descent. Time-dependent parameters of the Gaussian transitions can also be learned.

FIG. 10 shows an example of a computing device 1000 for document processing according to aspects of the present disclosure. In one aspect, computing device 1000 includes processor(s) 1005, memory subsystem 1010, communication interface 1015, I/O interface 1020, user interface component(s) 1025, and channel 1030.

In some embodiments, computing device 1000 is an example of, or includes aspects of, document processing apparatus 200 of FIG. 2. In some embodiments, computing device 1000 includes one or more processors 1005 that can execute instructions stored in memory subsystem 1010 for obtaining a prompt including a document description describing a set of elements; generating a set of image assets based on the prompt using a generative neural network, where the set of image assets correspond to the set of elements of the document description; and generating a structured document matching the document description, where the structured document includes the set of image assets and metadata describing a relationship between the set of image assets.

According to some aspects, computing device 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing. The processors 1005 may be examples or, or include aspects of, the processor unit of FIG. 2.

According to some aspects, memory subsystem 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state. The memory subsystem 1010 may be an example of, or include aspects of, the memory unit of FIG. 2.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller. The I/O interface 1020 may be an example of, or include aspects of, the I/O module of FIG. 2.

According to some aspects, user interface component(s) 1025 enable a user to interact with computing device 1000. In some cases, user interface component(s) 1025 include an audio device, such as an external speaker system, an external display device such as a display screen, an input device (e.g., a remote-control device interfaced with a user interface directly or through the I/O controller), or a combination thereof. In some cases, user interface component(s) 1025 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a prompt including a document description describing a plurality of elements;
generating a plurality of image assets based on the prompt using a generative neural network, wherein the plurality of image assets correspond to the plurality of elements of the document description; and
generating a structured document matching the document description, wherein the structured document includes the plurality of image assets and metadata describing a relationship between the plurality of image assets.

2. The method of claim 1, further comprising:
encoding the prompt to obtain a text embedding, wherein the plurality of image assets are generated based on the text embedding.

3. The method of claim 1, further comprising:
initializing a noise vector in a latent space representing a plurality of document parts;
generating a latent vector representing the plurality of image assets based on the noise vector using the generative neural network; and
decoding the latent vector to obtain the plurality of image assets, wherein the plurality of image assets correspond to the plurality of document parts respectively.

4. The method of claim 3, further comprising:
decoding the latent vector to obtain a parameter for displaying an asset of the plurality of image assets.

5. The method of claim 3, wherein:
the latent vector is generated using a denoising diffusion implicit model (DDIM) process.

6. The method of claim 1, further comprising:
generating an additional asset by providing one or more of the plurality of image assets as input to the generative neural network, wherein the structured document includes the additional asset.

7. The method of claim 6, further comprising:
obtaining an additional prompt, wherein the additional asset is generated based on the additional prompt.

8. The method of claim 1, wherein:
the plurality of image assets includes a background image and a foreground image, and wherein the relationship comprises a layer ordering of the background image and the foreground image.

9. A method comprising:
obtaining training data including a structured document and a document description of the structured document, wherein the structured document includes a plurality of image assets and metadata describing a relationship between the plurality of image assets; and
training a generative neural network using the training data, wherein the generative neural network is trained to generate the plurality of image assets based on the document description.

10. The method of claim 9, further comprising:
generating a plurality of noise vectors corresponding to the structured document;
generating a plurality of predicted vectors corresponding to the plurality of noise vectors, respectively, using the generative neural network; and
comparing the plurality of predicted vectors to the plurality of noise vectors, wherein the training is based on the comparison.

11. The method of claim 9, further comprising:
encoding the plurality of image assets to obtain a latent vector in a latent space representing a plurality of document parts, wherein the generative neural network is trained to generate the latent vector.

12. The method of claim 11, further comprising:
training an encoder to encode the plurality of image assets.

13. The method of claim 9, wherein:
the generative neural network is trained using a denoising diffusion probabilistic model (DDPM) process.

14. The method of claim 9, wherein:
encoding the document description to obtain an encoded description, wherein the generative neural network is trained to generate the plurality of image assets based at least in part on the encoded description.

15. A system comprising:
at least one memory component;
at least one processing device coupled to the at least one memory component, wherein the processing device is configured to execute instructions stored in the at least one memory component;
a generative neural network comprising parameters stored in the at least one memory component, wherein the generative neural network is configured to generate a plurality of image assets based on a prompt; and
a document generator configured to generate a structured document including the plurality of image assets and metadata describing a relationship between the plurality of image assets.

16. The system of claim 15, further comprising:
a decoder configured to decode a latent vector generated by the generative neural network to obtain the plurality of image assets.

17. The system of claim 16, wherein the decoder comprises a decoder of a variational auto-encoder (VAE) model.

18. The system of claim 15, further comprising:
a text encoder configured to encode the prompt to obtain a text embedding, wherein the plurality of image assets are generated based on the text embedding.

19. The system of claim 18, wherein the text encoder comprises a multimodal text encoder configured to encode text and images in a joint embedding space.

20. The system of claim 18, wherein the generative neural network comprises a diffusion model based on a UNet architecture.
